(19) United States
(12) Patent Application Publication
(10) Pub. No.: US 2018/0186247 A1
(43) Pub. Date: Jul. 5, 2018

(54) CHARGING SYSTEM

(71) Applicant: EASYCHARGE.ME GMBH, Düsseldorf (DE)

(72) Inventor: Artur Sychov, Dusseldorf (DE)

(21) Appl. No.: 15/738,484

(22) PCT Filed: Jun. 27, 2016
(86) PCT No.: PCT/EP2016/064865

§ 371 Date: Dec. 20, 2017

(30) Foreign Application Priority Data
Jun. 26, 2015 (EP) 15174059.4

(51) Int. Cl. B60L 11/18; H02J 7/00; G08G 1/14

(52) U.S. Cl. CPC B60L 11/1846; B60L 11/1818; B60L 11/1825; H02J 7/0027; B60L 2270/36; B60L 11/1848; B60L 2230/16; B60L 2250/16; B60L 2250/22; G08G 1/149

(57) ABSTRACT

The present invention relates to a system for charging the battery of an electric vehicle parking on a parking space (501). The system comprises a charging unit (500) having an interface (503) for connection with a corresponding charging socket of the electric vehicle. According to the invention, the system comprises a projector unit (504), a control unit (505), and a detecting module (506). The projector unit (505) is adapted to project an image onto the floor area of the parking space (501). The projector unit (504) furthermore comprises an input for receiving control signals from the control unit (505). The detecting module (506) is adapted to detect status data of the system. The detecting module comprises an output for sending the status data to the control unit (505). The control unit comprises an input (511) for receiving the status data from the detecting module (506). The control unit (505) is adapted to control the projector unit (504) as a function of the status data. By detecting status data of the system it is possible to provide useful information to the user which enhances the user-friendliness and safety of the system.

The present invention relates to a system for charging the battery of an electric vehicle parking on a parking space. The system comprises a charging unit having an interface for connection with a corresponding charging socket of the electric vehicle.

In view of the shortening of conventional oil reserves and due to general efforts to decrease carbon dioxide emissions, the automobile industry more and more shifts its focus from combustion engines towards electrical engines. In the course of this development, more and more charging units for charging the battery of electric vehicles are provided in public or private traffic areas. However, the use of existing charging units is often uncomfortable and complicated.

It is the object of the present invention to provide a system for charging the battery of an electric vehicle which is more user friendly, which increases the safety of the charging system and which allows a more economic mode of operation. The object is solved by the inventive charging system of claim 1. Preferable embodiments are specified in the dependent claims.

According to the invention, the system comprises a projector unit, a control unit, and a detecting module. The projector unit is integrated into a housing being adapted to be mounted on the ceiling above the parking space.

The projector unit is adapted to project an image onto the floor area of the parking space. The projector unit furthermore comprises an input for receiving control signals from the control unit.

The detecting module is adapted to detect status data of the system. The detecting module comprises an output for sending the status data to the control unit.

The control unit comprises an input for receiving the status data from the detecting module. The control unit is adapted to control the projector unit as a function of the status data.

First of all a few terms used within the present invention are explained. The inventive system comprises a detecting module. The term module relates to technical functions and does not necessarily require a certain spatial arrangement of the elements which belong to the detecting module. In particular, different elements of the detecting module may be spatially separated.

The term projector unit describes an optical device which—by means of optical imaging—is capable of creating an image on a screen. The term image both comprises static images and moving images (videos).

If the control unit is adapted to control the projector unit, this means that the control unit may select image content which is to be projected onto the floor of the parking space. The control unit and/or the projector unit may comprise an image data storage from which the image content to be projected can be selected. Alternatively or in addition the control unit and/or the projector unit may comprise a wired or wireless data connection with a media server and/or with the data network, wherein the image content to be projected may be received from the media server and/or from the data network.

Status data of the charging system may relate to any physical condition which can be detected at or around the charging system by the detecting module.

The charging interface of the charging unit may be of any kind which allows a connection with a corresponding charging socket of an electric vehicle. If the charging interface is connected with the corresponding charging socket, the charging process may be started. The charging process may be controlled by the control unit.

In comparison with conventional charging systems the inventive system has several advantages in terms of user friendliness, user-safety and economic operation. In particular, by detecting status data of the system and controlling the projector unit as a function of the status data, it is possible to display images or moving images and, thus, to provide useful information for the user of the charging system, wherein different information may be provided in different conditions or states of the system.

For instance it is possible to display parking related information, safety related information, reservation information, or advertisement information on the floor of the parking space.

According to the invention, the projector unit is integrated into a housing being adapted to be mounted on the ceiling above the parking space. The term ceiling comprises any kind of covering, caping, or roofing structure arranged above the parking space. The term ceiling does not impose any limitations in terms of material, surface condition, or orientation of the ceiling. The inventive charging system may be used in any kind of parking space which provides such a ceiling, for instance a parking space in a garage or in a multistory parking structure. The provision of the projector unit at the ceiling above the parking space is particularly beneficial, as the complete floor area of the parking space can be used as a screen without any objects obstructing the optical path of the projector unit.

The inventive system comprises a housing which is adapted to be mounted on the ceiling above the parking space. The projector unit is integrated into the housing. Further elements such as the charging unit, the control unit, and/or the detecting module or parts of these elements may be partly or completely integrated into the housing.

In a preferred embodiment the charging unit comprises a charging arm. The charging arm comprises a first end and a second end, wherein the charging arm is mounted to the housing at the first end and wherein the charging interface is located at the second end. The charging arm spaces the charging interface from the projector unit in the horizontal direction. Within the present invention the term “horizontal” denotes a direction being essentially parallel to the floor area of the parking space. If the charging interface is spaced from the projector unit in the horizontal direction, this means that an imaginary projection of the projector unit into a horizontally oriented plane is spaced from an imaginary projection of the charging interface into this plane. By means of the charging arm and the horizontal distance between the projector unit and the charging interface it is ensured that the charging interface and any charging connector and/or cables for charging an electric vehicle do not obstruct the light path from the projector unit to the floor area. In a preferred embodiment, the horizontal distance is between 0.5 m and 2.2 m, more preferably between 0.8 m and 1.8 m, and even more preferably between 1 m and 1.6 m.

Preferably, the charging arm is rotatable with respect to the housing around an axis being essentially vertical. The provision of a charging arm being rotatable around an essentially vertical axis allows to adapt the charging unit to electric vehicles having their charging socket either on the left side or on the right side of the vehicle. Due to the horizontal distance it is ensured in every rotating position that the light path remains unobstructed.

In a preferred embodiment the charging arm comprises a first segment and a second segment, wherein the charging arm is mounted to the housing at the first segment and wherein the charging interface is arranged at the second segment, wherein the first segment is oriented essentially horizontally and wherein the second segment encloses an angle between 45° and 135° with a horizontal plane, preferably between 70° and 110°, more preferably around 90°. By providing two segments having the orientation noted above, the charging interface is easily accessible to a user of an electric vehicle parked on the parking space, while at the same time the light path still remains unobstructed.

It is furthermore preferred that the charging arm is rotatable around the axis of the first segment. If the charging arm is rotatable around the axis of the first segment which is essentially horizontal, the charging arm can be moved between a use-position and a store-position. In the use-position, the charging interface is easily accessible by a user of the charging system, wherein in the store-position, the charging interface is located close to the ceiling above the parking space so that the charging arm does not collide with the vehicle during parking operations. Preferably, the status data comprise reservation data regarding the reservation of the parking space by a user. The detecting module may be adapted to obtain the reservation data from a reservation database. This feature allows to display reservation related information on the floor of the parking space. For instance, it is possible to indicate that the parking space is reserved by a certain vehicle user. The indication may be achieved by means of an according sign comprising the vehicle registration number. If the parking space is not reserved, other kind of information may be displayed on the floor of the parking space, for instance advertisement, weather information, or news.

In a preferred embodiment, the detecting module comprises a motion detector, wherein the status information comprises movement information recorded by the motion detector. The motion detector may detect movement of persons and/or vehicles in a range of 20 m, 15 m, 10 m, 5 m, 2 m, or 1 m around the parking space or directly within the parking space area. The detection range of the motion detector may be variable. In a preferred mode of operation, the motion detector sends movement information to the control unit if a vehicle leaves the parking space, wherein the control unit subsequently induces the projector to display an image, for example advertisement, to the floor of the parking space.

In a preferred embodiment the detecting module furthermore comprises a camera unit, wherein the status data comprise picture information captured by the camera unit. In this case the content which is displayed on the floor of the parking space may be selected as a function of the picture information captured by the camera unit. In a further preferred mode of operation, the camera unit may, for instance, be adapted to capture the registration number of a vehicle approaching the parking space. The registration number may be compared with a registration number saved in a reservation database. In case of matching registration numbers, i.e. in case the parking space is reserved for the approaching vehicle, a personalized message such as a welcome message may be displayed on the parking space. If, in the contrary, the parking space is not reserved for the approaching vehicle, a different message, such as a warning message may be displayed. Furthermore, the registration number of an unauthorized vehicle parking on the parking space may be saved.

Additionally or alternatively, the detecting module may comprise a data connection unit being adapted to establish a connection with a user, wherein the status data comprise user information. To “establish a connection with a user” means that the data connection unit may connect with a mobile device of the user or with the electric vehicle of the user. The data connection unit may use GSM, Wifi, or any other wireless connection standard. Thus, a user may establish a connection with the data connection unit when approaching the parking space. The user may be identified by means of the data connection unit, wherein, for instance, a personalized welcome message may be displayed after the user has connected with the connection unit.

The control unit may also be adapted to control the camera unit as a function of movement information detected by the motion detector. This feature provides a further preferred mode of operation, in which the camera captures picture information of a person approaching the vehicle parking on the parking space. This provides a protection against thieves and, thus, increases the safety. Preferably, the data connection unit is adapted to send image information captured by the camera unit to a mobile device of the user.

It is preferred that the inventive system furthermore comprises a speaker unit for generating audio signals, wherein the speaker unit is controlled by the control unit as a function of the status data. This feature allows to provide audio content such as audio messages or warnings or music or audio advertisement. Furthermore, the image or video content displayed on the floor of the parking space may be supplemented with audio content, i.e. it is possible to provide audiovisual content. If the control unit is adapted to control the speaker unit, this means that the control unit may select audio content which is to be output by the speaker unit. The control unit and/or the speaker unit may select the audio content to be output from the media server. Alternatively or in addition the speaker unit and/or the control unit may comprise a wired or wireless data connection with the media server and/or with the data network, wherein the audio content may be received from the media server and/or from the data network.

In a preferred embodiment, the camera unit is adapted to monitor the position of a vehicle during a parking process. Preferably, the projector unit and/or the speaker unit is controlled by the control unit as a function of the picture information captured by the camera unit. The projector unit and/or the speaker unit may provide a warning signal, if a vehicle approaches a boundary or an obstruction of the parking space (such as a wall, or a pillar or a different vehicle being parked on a neighboring parking space) during a parking process.

The charging system may also comprise a laser projector being adapted to project a laser line image to the floor of the parking space, wherein the laser projector is controlled by the control unit. By means of such a laser projector it is possible to display high resolution text elements or sharp boundary lines, for instance a rectangular boundary line around the parking space area. The projection of boundary lines indicating the extent of the parking space leads to an increased safety.

The charging system may furthermore comprise a second laser projector, wherein the first and second laser projectors are located remote from each other. By using two laser projectors which are located remote from each other the maximum projection area is increased. At least one of the laser projectors preferably comprises a cylindrical lens and/or a Powell lens being adapted to project a preferably rectangular marking around the parking space. In a preferred embodiment, the laser projectors have a laser power of less than 5 mW.

Preferably, the projector unit is adapted to provide a throw ratio between 0.1 and 3, preferably between 0.2 and 2, more preferably between 0.3 and 1. The term “throw” denotes the distance between a projector and a screen onto which the projector image is projected. The term throw ratio denotes the ratio of the throw to the screen width.

Preferably, the projector unit comprises an optical zoom being adapted to provide a variable throw distance. It is furthermore preferred, that the optical zoom is adapted to provide a throw distance between 0.5 m and 6 m, preferably between 1 m and 4 m. Preferably, the projector unit is a digital light processing projector. The projector unit may be adapted to provide a brightness of more than 1000 ANSI-lumen, preferably more than 2000 ANSI-lumen, more preferably more than 3000 ANSI-lumen. In a preferred embodiment, the projector unit is adapted to provide an ANSI-contrast of more than 4000:1, preferably more than 8000:1, more preferably more than 10000:1. The projector unit may furthermore be adapted to provide an image resolution of at least 1280×800 pixels, preferably of 1920×1080 pixels. The above-noted technical specifications of the projector unit ensure a sufficient dimension and a sufficient visibility and quality of the image which is projected to the floor of the parking space. Higher resolutions may be used if desired. This may e.g. include 4K, 8K, or other.

The invention furthermore relates to a method of operating the inventive charging system, comprising the following steps:
a. detect if the parking space is occupied by a vehicle;
b. if the parking space (501) is not occupied:
   i. project a first image or moving image (516) to the floor of the parking space (501);
c. if the parking space (501) is occupied:
   i. detect if the vehicle leaves the parking space (501);
   ii. if the vehicle has left the parking space (501), project the first image or moving image (516) to the floor of the parking space (501).

In a preferred embodiment, the inventive method furthermore comprises the following steps:
a. detect if the parking space (501) is reserved by a user;
b. if the parking space (501) is reserved by a user, detect if the vehicle of the user approaches the parking space (501);
c. if the vehicle of the user approaches the parking space (501) project a second image (516) to the floor of the parking space (501).

Preferably, the first image or moving image comprises advertisement. The second image or moving image may comprise individual user information, preferably allowing the user to identify the parking space.

The features, objects and advantages of the invention will become further apparent by the following exemplary description of preferred embodiments in conjunction with the accompanying drawings, which show:

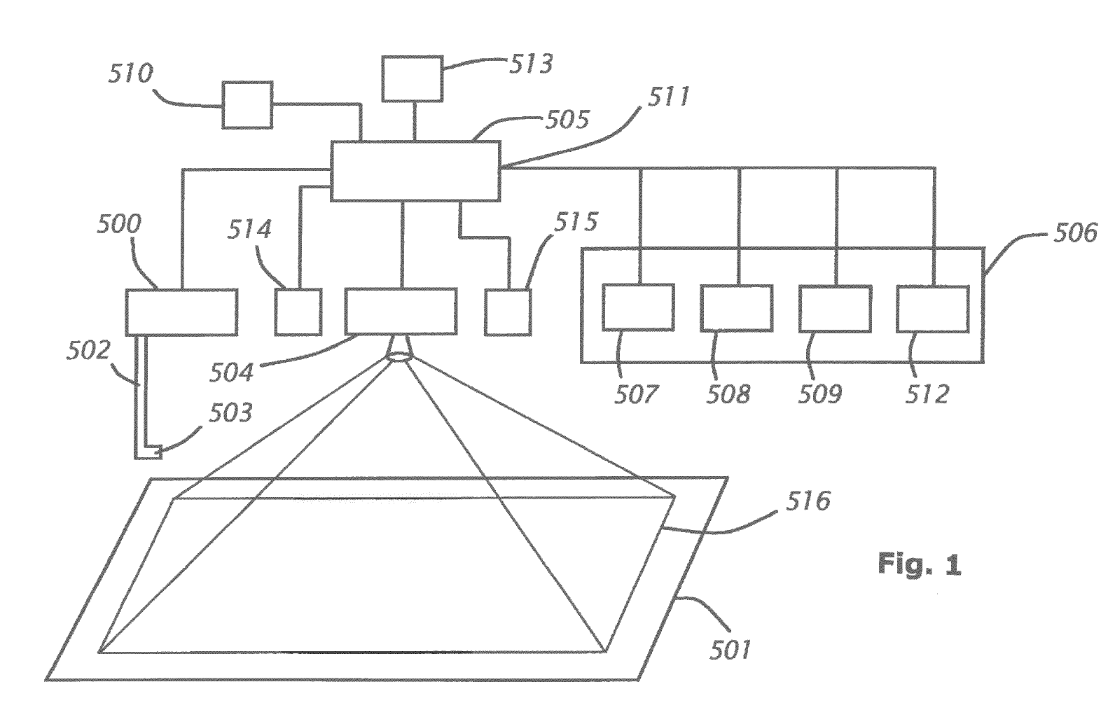

FIG. 1: a schematic illustration of an embodiment of the inventive charging system;

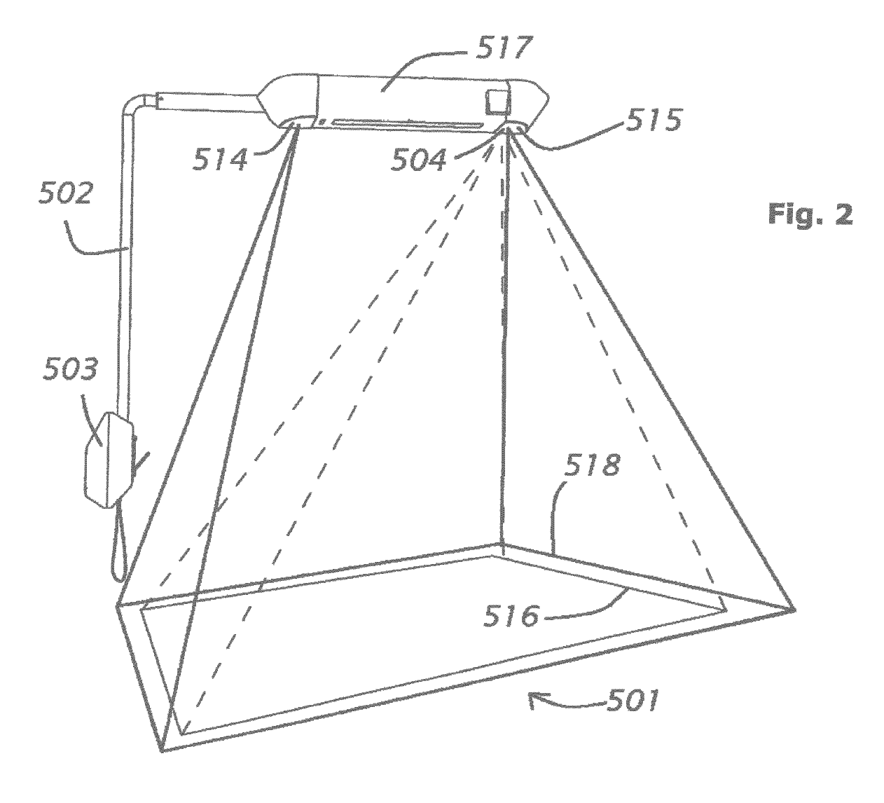

FIG. 2: a three-dimensional illustration of the embodiment of FIG. 1;

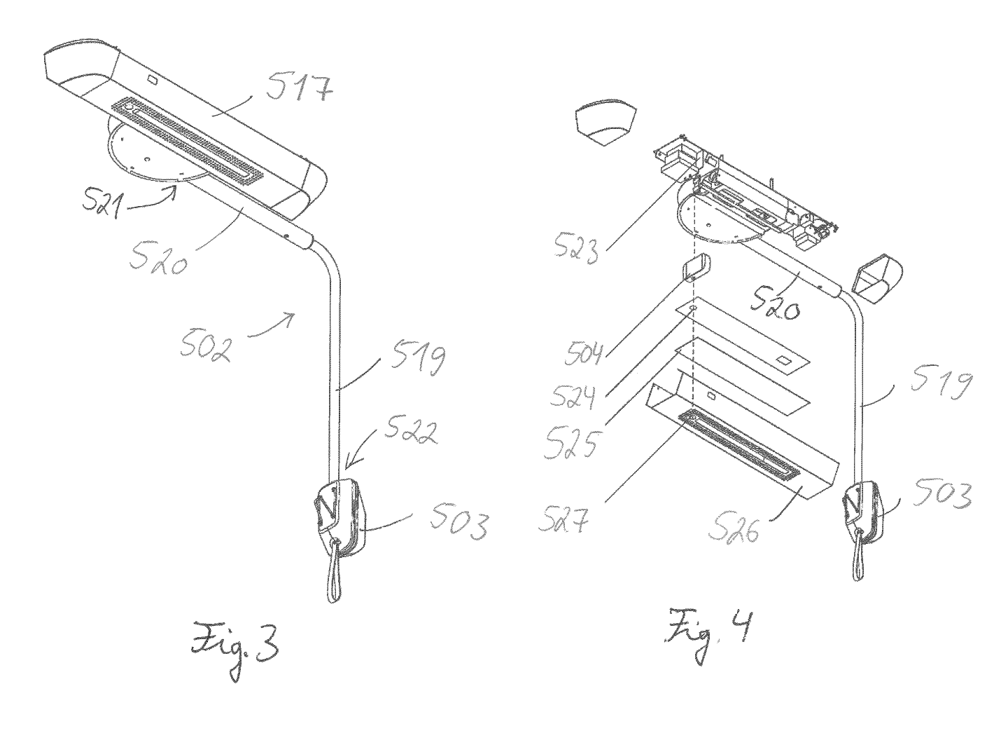

FIG. 3: a three-dimensional illustration of another embodiment of the inventive charging system;

FIG. 4: an exploded view of the embodiment of FIG. 3.

FIG. 1 shows a schematic illustration of a first embodiment of the inventive charging system. The schematic illustration does not reflect the spatial arrangement of the elements. The charging system comprises a charging unit 500 for charging the battery of an electric vehicle parking on a parking space 501. The charging unit 500 comprises a charging arm 502 and a charging interface 503 for connection with a corresponding charging socket of the electric vehicle (not shown in FIG. 1). The charging arm 502 is movable and can be moved to an adequate position for establishing the connection between the charging interface 503 and the charging socket.

The system furthermore comprises a projector unit 504, a first laser projector 514, a second laser projector 515, a speaker unit 510, a control unit 505, a media server 513, and a detecting module 506. The projector unit 504 is adapted to project an image 516 to the floor area of the parking space 501. The detecting module 506 comprises a camera unit 507, a motion detector 508, a data connection unit 509 and a reservation database 512. In an alternative embodiment the reservation database 512 may be arranged remote from the charging system, wherein the reservation information is transmitted by a wireless or a wired data connection to the detection module 506 and/or to the control unit 505.

The control unit 505 comprises an input 511 for receiving status data from the detecting module 506. In the embodiment of FIG. 1 there are four different kind of status data: picture information captured by the camera unit 507, movement information recorded by the motion detector 508, user information of a user being connected to the data connection unit 509, and reservation information provided by the reservation database 512. The data connection unit 509 is adapted to establish a wireless data connection with a mobile device of a user or with a vehicle of a user.

The control unit 505 controls the projector unit 504, the first laser projector 514, the second laser projector 515, and the speaker unit 510 as a function of the picture information, movement information, user information, and reservation information. In a first mode of operation, the control unit checks by means of picture information and/or by means of movement information, if the parking space is occupied by a vehicle or not.

If the parking space is vacant, the control unit 505 selects advertisement media content from the media server 513 which is to be projected by the projector unit 504 onto the floor of the parking space 501 and/or output by the speaker unit 510. For this purpose, the control unit is connected to the media server 513 by a data connection.

If a user reserves the parking space 501, a reservation information is sent from the reservation database 512 to the control unit 505. Subsequently, the control unit 505 selects different media content to be projected by the projector unit 504 and/or output by the speaker unit 510. In particular, reservation information allowing a user to identify the reserved parking space are displayed on the floor of the parking space.

In addition, the control unit 505 sends a control signal to the laser projectors 514, 515, wherein the laser projectors 514, 514 subsequently project text information comprising the registration number of the user or of his vehicle onto the floor of the parking space 501.

When a vehicle arrives at the charging system, the motion detector 508 records movement information and sends the movement information to the control unit 505. Subsequently the control unit 505 sends a control signal to the camera unit 507. The camera unit 507 subsequently captures the registration number of the arriving vehicle, wherein the control unit 505 compares the registration number captured by the camera unit 507 with the registration number saved in the reservation database. If the parking space is reserved for the vehicle arriving at the parking space, the captured registration number matches the saved registration number. In this case, the control unit 505 induces the projector unit 504 and/or the laser projectors 514, 515 to project a welcome message onto the floor of the parking space 501. In addition, the control unit 505 induces the speaker unit 510 to output an audio welcome message. In addition or alternatively, the identification of the user can be conducted by establishing a connection between the data connection unit 509 and a mobile device of the user or the vehicle of the user.

If the registration number of the vehicle arriving at the parking space is not saved in the reservation database, the control unit 505 induces the projector device 504 and/or the laser projectors 514, 515 to display a warning message which may point out to the vehicle driver that this parking space is reserved for someone else. If a non-registered vehicle is parked on the parking space 501, the registration number of the vehicle is saved by the control unit 505.

If a registered vehicle is parked on the parking space 501, the camera unit 507 monitors the vehicle during the parking process in order to ensure a safe parking process. For this purpose, the projector unit 504 and the speaker unit 510 are controlled as a function of the picture information recorded by the camera unit 507. In particular, a warning signal is displayed by the projector unit 504 and a warning sound is output by the speaker unit 510, in case the vehicle comes close to an obstacle (such as a wall, a pillar or a different vehicle) during the parking process.

Furthermore, the camera unit 507 monitors the car after the parking process in order to protect the vehicle against theft. In particular, the camera unit 507 captures picture information of the area around the parking space 501, if an approach of a person is detected by the motion detector 508. The captured picture information is sent to a mobile device of the user via the data connection unit 509.

FIG. 2 shows a three-dimensional illustration of the embodiment of FIG. 1. As can be seen, the inventive system comprises a housing 517, which is mounted on the ceiling above the parking space 501. The projector device 504, the control module 505, the laser projectors 514, 515, the detecting module 506, and the speaker unit 510 are integrated into the housing 517 and, thus, are not visible in FIG. 2. The charging unit 500 is partly integrated into the housing. The charging arm 502 and the charging interface 503 are attached to the housing 517. The charging arm 502 is rotatable with respect to the housing 517 and can be moved between a stored position in which it is oriented essentially in parallel to the ceiling (not shown in FIG. 2) and a use position in which it is oriented essentially perpendicular to the ceiling (as shown in FIG. 2).

Due to the attachment on the ceiling, the light path of the projector unit 504 and the laser projectors 514, 515 is unobstructed and a large area of the parking space 501 can be used as a screen. In this way a large scale image 516 and a large scale laser projection area 518 can be generated.

As shown in FIG. 2, the laser projectors 514, 515 are arranged remote from each other at opposite sides of the housing 517. Thus, the size of the projection area 518 of the laser projectors 514, 515 is increased even more.

FIG. 3 shows a three-dimensional illustration of another embodiment of the present invention. FIG. 4 shows the embodiment of FIG. 3 in an exploded view. With regard to the embodiment of FIGS. 1 and 2 like elements are denoted with like reference numerals. The embodiment of FIGS. 3 and 4 comprise a projector unit 504 being integrated into the housing 517. Within the housing a mounting plate 523 is arranged, to which the projector unit 504 is attached. Within the housing 517 there is furthermore provided an adhesive foil 524 having an opening for the light created by the projector unit and a plate of acrylic glass 525. Furthermore, the housing 517 comprises an outer cage 526 for protection purposes. The outer cage 526 has an opening 527 for the light created by the projector unit 504. In another embodiment instead of the opening 527 a lens may be provided for projecting the image of the projecting unit 504 to the floor area of the parking space (not shown in FIGS. 3 and 4).

In the embodiment of FIGS. 3 and 4, the charging arm 502 comprises a first segment 520 and a second segment 519, wherein the segments enclose a 90° angle between each other. This means that the first segment 520 is essentially oriented horizontally and the second segment 519 is essentially oriented vertically.

At its first end 521 the charging arm 502 is rotatably attached to the housing 517 of the charging unit. The charging arm 502 can, thus, be rotated around the housing 517 around an essentially vertical axis. The first segment 520 has a length of about 1.3 m. By means of the first segment, the charging interface 503 is spaced from the projecting unit 504 in the horizontal direction by about 1.5 m. If the charging arms rotated around the essentially vertical axis by 180°, the charging interface is still spaced from the projector unit 504 in the horizontal direction by about 1.1 m. Accordingly, the charging arm, the charging interface, and any connectors or cables which may be attached to the interface 503 do not obstruct the light path from the projector unit 504 to the floor area of the parking space.

The charging arm 502 is furthermore rotatable about the axis of the first segment 520. By means of a rotation around the axis of the first segment 520 the charging arm can be moved from the use-position shown in FIG. 3 into a store-position in which the charging interface is arranged close to the ceiling above the parking space (not shown). In the use-position the charging arm 502 is easily accessible to a user, wherein in the store-position it does not impede the user's vehicle during parking processes.

1. System for charging the battery of an electric vehicle parking on a parking space (501), wherein the system comprises a charging unit (500), a projector unit (504), a control unit (505), and a detecting module (506), wherein the projector unit (504) is integrated into a housing (517) being adapted to be mounted on the ceiling above the parking space (501), wherein
a. the charging unit (500) comprises a charging interface (503) for connection with a corresponding charging socket of the electric vehicle;
b. the projector unit (504) is adapted to project an image (516) onto the floor area of the parking space (501), wherein the projector unit (504) comprises an input for receiving control signals from the control unit (505);
c. the detecting module (506) is adapted to detect status data of the charging system wherein the detecting module comprises an output for sending the status data to the control unit (505); and
d. the control unit (505) comprises an input (511) for receiving the status data from the detecting module (506), wherein the control unit (505) is adapted to control the projector unit (504) as a function of the status data.

2. System according to claim 1, characterized in that the charging unit (500) comprises a charging arm (502) comprising a first end (521) and a second end (522), wherein the charging arm (502) is mounted to the housing (517) at the first end (521) and wherein the charging interface (503) is located at the second end (522), wherein the charging arm (502) spaces the charging interface (503) from the projector unit (504) in the horizontal direction.

3. System according to claim 2, characterized in that the charging arm (502) is rotatable with respect to the housing (517) around an axis being essentially vertical.

4. System according to one of claim 2 or 3, characterized in that the charging arm (502) comprises a first segment (520) and a second segment (519), wherein the charging arm is mounted to the housing (517) at the first segment (520) and wherein the charging interface (503) is arranged at the second segment (519), wherein the first segment (520) is oriented essentially horizontally and wherein the second segment (519) encloses an angle between 45° and 135° with a horizontal plane, preferably between 70° and 110°, more preferably around 90°.

5. System according to claim 4, characterized in that the charging arm (502) is rotatable about the axis of the first segment (520).

6. System according to one of claims 2 to 5, characterized in that the horizontal distance is between 0.5 m and 2.2 m, preferably between 0.8 m and 1.8 m, more preferably between 1 m and 1.6 m.

7. System according to one of claims 1 to 6, characterized in that the status data comprise reservation data regarding the reservation of the parking space (501) by a user.

8. System according to one of claims 1 to 7, characterized in that the detecting module (506) comprises a motion detector (508), wherein the status information comprises movement information recorded by the motion detector (508).

9. System according to one of claims 1 to 8, characterized in that the detecting module (506) comprises a camera unit (507), wherein the status data comprise picture information captured by the camera unit (507), wherein the detecting module (506) preferably comprises a data connection unit (509) being adapted to establish a connection with a user, wherein the status data comprise user information.

10. System according to claim 8, characterized in that the detecting module comprises a camera unit (507), wherein the status data comprise picture information captured by the camera unit (507), wherein the control unit (505) is adapted to control the camera unit (507) as a function of movement information detected by the motion detector (508), wherein the system preferably comprises a speaker unit (510) for generating audio signals, wherein the speaker unit (510) is preferably controlled by the control unit (505) as a function of the status data.

11. System according to one of claims 1 to 10, characterized in that the projector unit (504) comprises a laser projector (514, 515) being adapted to project a laser line image to the floor of the parking space, wherein the laser projector (514, 515) is controlled by the control unit (505) as a function of the status data.

12. Method of operating a charging system according to one of claims 1 to 11, comprising the following steps:
a. detect if the parking space (501) is occupied by a vehicle;
b. if the parking space (501) is not occupied:
i. project a first image or moving image (516) to the floor of the parking space (501);
c. if the parking space (501) is occupied:
i. detect if the vehicle leaves the parking space (501);
ii. if the vehicle has left the parking space (501), project the first image or moving image (516) to the floor of the parking space (501).

13. Method according to claim 12, characterized in that it furthermore comprises the steps:
a. detect if the parking space (501) is reserved by a user;
b. if the parking space (501) is reserved by a user, detect if the vehicle of the user approaches the parking space (501);
c. if the vehicle of the user approaches the parking space (501) project a second image (516) to the floor of the parking space (501).

14. Method according to claim 12 or 13, characterized in that the first image or moving image comprises advertisement.

15. Method according to one of claims 12 to 14, characterized in that the second image or moving image comprises individual user information, preferably allowing the user to identify the parking space (501).
